(19) United States
(12) Patent Application Publication
(10) Pub. No.: US 2024/0405864 A1
(43) Pub. Date: Dec. 5, 2024

(54) FAULT-TOLERANT DATA DIODES FOR ONE-WAY TRANSFER SYSTEMS

(71) Applicant: Microsoft Technology Licensing, LLC, Redmond, WA (US)

(72) Inventors: Jeffrey Allen WEST, Woodinville, WA (US); Kenneth Russell KLINZMAN, Redmond, WA (US); David Scott WILLARD, Monroe, WA (US)

(73) Assignee: Microsoft Technology Licensing, LLC, Redmond, WA (US)

(21) Appl. No.: 18/326,457

(22) Filed: May 31, 2023

(51) Int. Cl. H04B 10/038

(52) U.S. Cl. CPC H04B 10/038

(57) ABSTRACT

Methods and systems for transferring data through a one-way transfer (OWT) system using a fault-tolerant data diode. Data from a source computing environment may be converted to an optical signal that is then split into duplicate signals. The duplicate optical signals are received by two receiving devices that have optical receivers. The receiving devices operate as either a primary device or a secondary device to continue transmission of the received data. The operating states of the receiving devices may change based the health or status of the respective devices.

### BACKGROUND

In data transfer and communications systems, communication may generally be performed in a two-way manner. For instance, two devices in communication with one another may exchange data in both directions. This ability allows for confirmations or acknowledgements that data has been received and processed correctly. In cases where the data is not received or processed correctly, such as due to dropped packets or corrupted data, the receiving device is able to request that the data be retransmitted. In systems where only one-way communication is implemented, no such acknowledgements or requests for the resending of data are available.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods relating to using fault-tolerant data diodes in one-way transfer (OWT) systems. The OWT systems include components that restrict the flow of data in a single direction through the system while providing additional reliability enhancements to help ensure that data is handled correctly and is tolerant to faults in the devices of the systems. For example, the system may include a transmitting computing device with an optical transmitter limited to transmit-only functions. Data is then optically transmitted through a passive beam splitter that is immune to power loss or other electrical-based failures. The divided optical signal from the beam splitter is provided to at least two receiving devices. Each of the receiving devices operates as either a primary device or a secondary device for processing and further transmitting the data through the system. The operating state of the receiving device as either the primary device or the secondary device may change based on status data exchanged between the two receiving devices. For instance, if the primary device becomes nonfunctional, the secondary device changes to the primary device and takes over the processing and transmitting of the data further into the system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIGS. 1A-C depict example one-way transfer (OWT) systems using a fault-tolerant data diode.

FIG. 2 depicts an example OWT system with multiple availability zones.

FIG. 3 depicts an example method for operating a fault-tolerant data diode in one-way transfer systems.

FIGS. 4A-B depict another example method for operating fault-tolerant data diodes in one-way transfer systems.

FIG. 5 is a block diagram illustrating example physical components of a computing device for practicing aspects of the disclosure.

### DETAILED DESCRIPTION

A one-way transfer system (OWT) refers to a computing system which uses one or more data diodes to ensure that data can be transferred only unidirectionally through the respective computing devices of the computing system. In examples, the data diodes ensure unidirectional data packet transfer through implementation of hardware and/or software components, such as a transmit-only network interface card (NIC).

OWT systems may be used to protect a network or endpoints against outbound data transmissions, malicious inbound data transmissions (e.g., viruses and malware), and cyberattacks. As one example, OWT systems facilitate the transfer of data between computing environments having the same or different security levels (e.g., high-security or low-security), where at least one of the computing environments is lower trust with respect to another of the computing environments. For instance, a first computing environment that is high trust with respect to the devices of the first computing environment and/or with respect to devices of one or more other computing environments receives data from a second computing environment that is considered to be low trust by the first computing environment.

In examples, a high-trust computing environment may be a system or network where the devices, applications, and users are considered trustworthy, and security measures are in place to establish and maintain that trust. In this type of computing environment, the devices and/or parties involved, such as devices, software, and users, are often authenticated, authorized, and/or adhere to established security policies and best practices. High-trust computing environments usually have rigorous access controls, encryption, and monitoring to ensure that trust is maintained and to minimize the risk of unauthorized access, data breaches, or other security incidents. Devices within high-trust computing environments may be authorized to access or be accessed by other devices based on security techniques that are implemented by the high-trust computing environments (e.g., unique encryption keys, secrets, or other cryptographical techniques). For instance, the communications transmitted by a high-trust computing environment may be considered trustworthy by other computing environments or devices based on the high-trust computing environment (or devices thereof) being included in an allowlist (e.g., a list of approved devices and/or computing environments). Alternatively, the communications transmitted by a high-trust computing environment may be considered trustworthy based on a password or credential provided with the communications. In some examples, the devices in a high-trust computing environment do not require authentication to access or be accessed by other devices. A high-trust computing environment generally does not expose the security techniques implemented by the high-trust computing environment to other computing environments, which may be considered low-trust or no-trust environments by the high-trust environment.

By contrast, a low-trust or no-trust environment may be a system or network where the devices, applications, and/or users are not implicitly trusted or where there's a high risk of unauthorized access or malicious activities. This type of environment might have limited or no security measures in place, or the environment may be one where a high number of external or unmanaged devices are connected Alternatively or additionally, a low-trust or no-trust environment refers to an environment in which the devices are not considered to be secured or trustworthy by other devices within and/or external to the low-trust or no-trust environments. As the security techniques implemented by the high-trust computing environment are not exposed to low-trust or no-trust environments, low-trust or no-trust environments may not be able to access or communicate with a high-trust computing environment without performing various authorization and/or authentication steps that need not be performed by devices in high-trust environments.

Due to the unidirectional data transmission of OWT system, there is no confirmation that data sent over the unidirectional transmission line has been received by the receiving device and/or processed correctly by the receiving device. In contrast, in bi-directional systems, communication protocols such as the Transmission Control Protocol (TCP) may be used where confirmations can be sent back to the transmitting device. For example, with TCP, when a connection is established between two devices, the two devices exchange a series of messages to synchronize and establish the connection parameters. Then, when the transmitting device sends data, the receiving device returns an acknowledgment (ACK) message back to the transmitting device to confirm that it has received the data. If the transmitting device does not receive an ACK within a certain amount of time, the transmitting device will resend the data. With OWT systems, no such ACK messages are possible because communications cannot be sent back to the transmitting device from the receiving device. As a result, there must be robust systems in place to help ensure that the data transmitted from the transmitting device is actually received and properly handled by the receiving device. If no such systems are in place, the reliability of the system would be significantly reduced.

The present technology introduces such robust systems that are tolerant to faults within the receiving device to better ensure that the data received from the transmitting device is properly handled. For example, the system may include a transmitting computing device with an optical transmitter limited to transmit-only functions. Data is then optically transmitted through a passive beam splitter that is immune to power loss or other electrical-based failures. The divided optical signal from the beam splitter is provided to at least two receiving devices. Each of the receiving devices operates as either a primary device or a secondary device for processing and further transmitting the data through the system. The operating state of the receiving device as either the primary device or the secondary device may change based on status data exchanged between the two receiving devices. For instance, if the primary device becomes nonfunctional, the secondary device changes to the primary device and takes over the processing and transmitting of the data further into the system.

Thus, even where there is a fault in one of the receiving devices, another receiving device ensures that the data is still handled and transmitted further through the system. In addition, the present system increases reliability without having to significantly increase or duplicate bandwidth requirements. For example, rather than having the receiving devices both transmit data further through the system (which would double bandwidth usage), the receiving devices efficiently alternate operating statuses to improve reliability without duplicating processing and transmission operations.

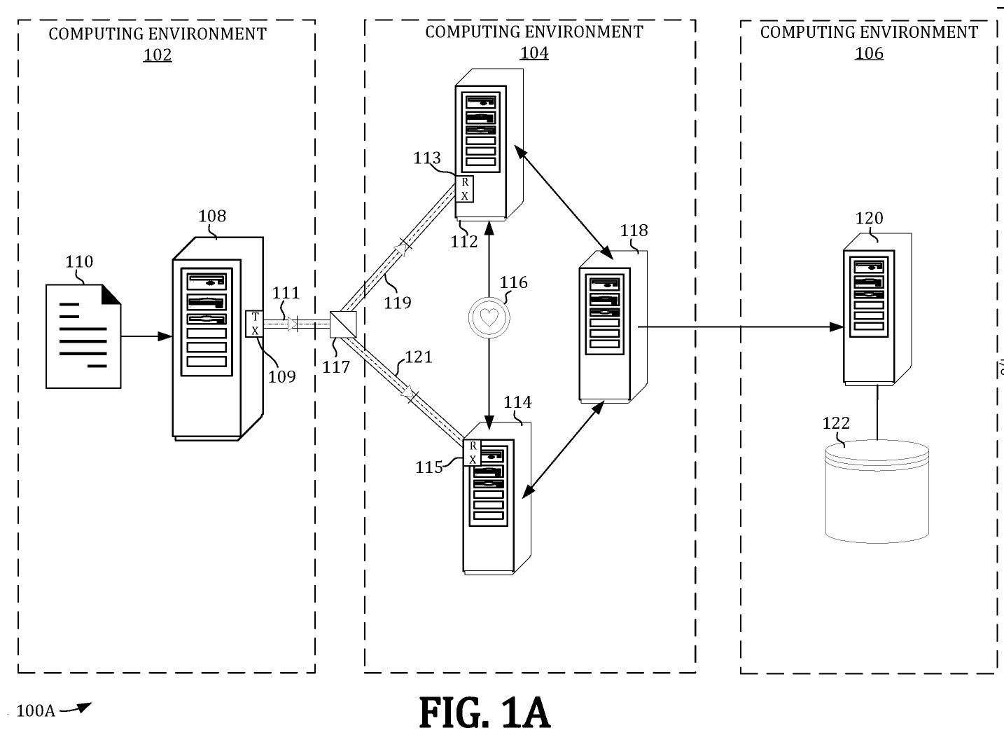

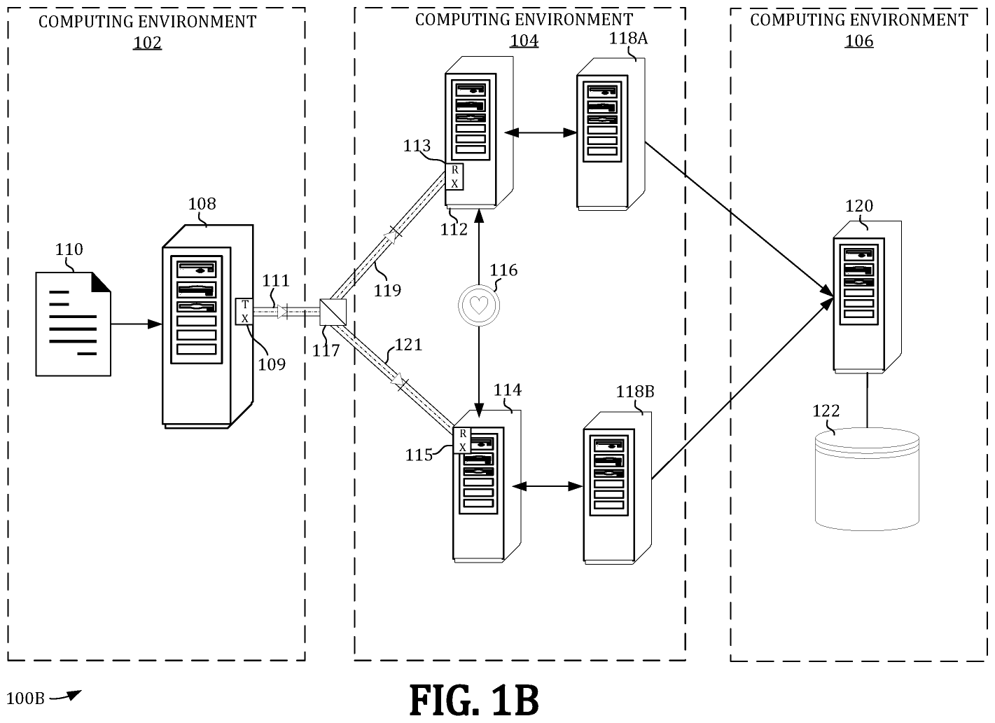

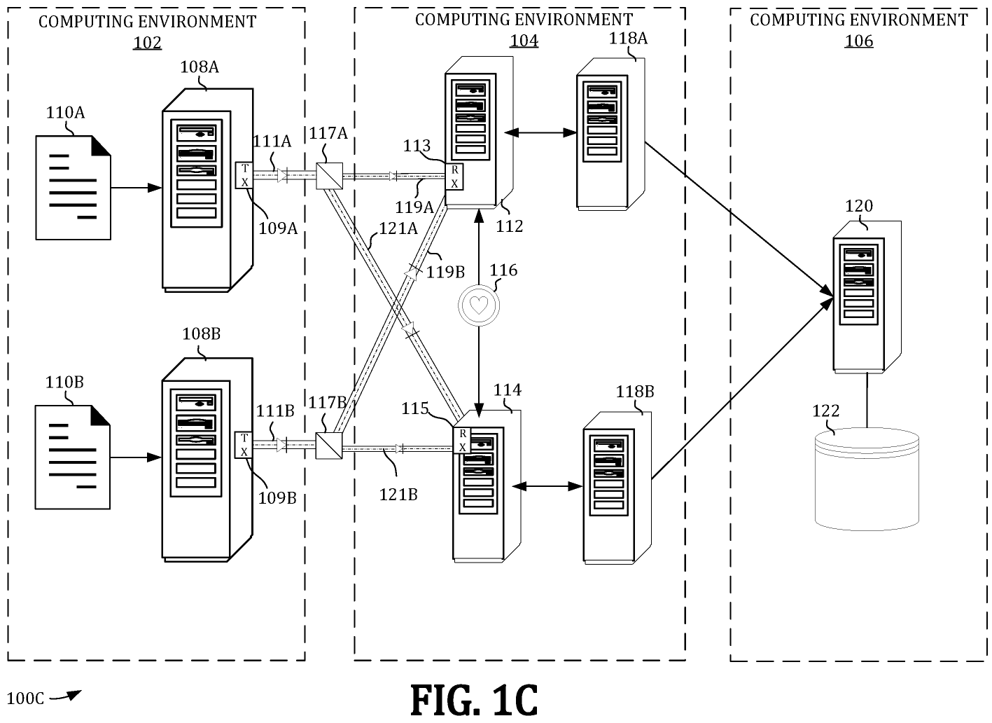

FIG. 1A depicts an example one-way transfer (OWT) system 100A using a fault-tolerant data diode. System 100A, as presented, is a combination of interdependent components that interact to form an integrated whole. Components of system 100A may be hardware components or software components (e.g., application programming interfaces (APIs), modules, runtime libraries) implemented on and/or executed by hardware components of system 100A. In one example, components of system 100A are distributed across multiple processing devices or computing systems.

System 100A represents an OWT system for transmitting data between different computing environments. System 100A includes a first computing environment 102, a second computing environment 104, and a third computing environment 106. In some examples, computing environments 102, 104, and 106 are implemented in a cloud computing environment or another type of distributed computing environment and are subject to one or more distributed computing models/services (e.g., Infrastructure as a Service (IaaS), Platform as a Service (PaaS), in Software as a Service (Saas), Functions as a Service (FaaS)). In some examples, each environment is a separate network or sub-network. Although FIG. 1 is depicted as including a particular combination of computing environments and devices, the scale and structure of devices and computing environments described herein may vary and may include additional or fewer components than those described in FIG. 1A.

Further, although examples presented herein will be described in the context of OWT systems and data transfers between low-security, or low-trust, computing environments and high-security, or high-trust, computing environments, the examples are also applicable to other types of data transfers between computing environments of various (or the same) types and security levels. For instance, the first computing environment 102 may also be referred to as a source environment, and the third computing environment 106 may be referred to as a destination environment.

In embodiments, the first computing environment 102 represents a low-trust computing environment in which devices executing within computing environment 102 are not trusted by devices executing within the second computing environment 104 or the third computing environment 106. In such examples, the first computing environment 102 may be physically separated from the second computing environment 104 and/or the third computing environment 106 such that the first computing environment 102 is in a first physical location (e.g., region, building, room, and/or server rack) and computing environments 104 or 106 are in one or more other physical locations. Alternatively, in other examples, the computing environments 102, 104, and 106 are all be located in the same physical location.

In the example depicted, the first computing environment 102 includes a computing device 108. The computing device 108 may be referred to herein as the low-side computing device 108 or the transmitting device 108. The low-side computing device 108 receives input data 110 from users or computing devices within, or accessible to, the first computing environment 102. In embodiments, input data 110 includes one or more types of data, such as file data, audio data, touch-based data, text-based data, gesture data, image data, and/or video data, among others. The low-side computing device 108 may serialize the input data 110 by separating the input data 110 into one or more data chunks using a file segmentation service or utility, which may be implemented locally on the low-side computing device 108 or accessed remotely by the low-side computing device 108.

The segmented input data 110 is then transmitted optically one way to the second computing environment 104, which may be a higher-security or higher-trust computing environment with respect to the first computing environment 102. The second computing environment 104 includes computing device 112 and computing device 114. In some examples, computing devices 112 and 114 are located proximate the low-side computing device 108 (e.g., in the same building or room). For instance, computing devices 112, 114 and low-side computing device 108 may be located in the same room of a data center such that the low-side computing device 108 is located in a first data rack (e.g., server rack or data cabinet), and the computing devices 112, 114 are located in a second data rack or a different shelf of the first data rack. In such examples, the low-side computing device 108 and the computing devices 112, 114 may be directly connected via point-to-point cabling, which may be optical as discussed further herein.

The computing device 112 and the computing device 114 may also be physically separated from one another to help ensure reliability and redundancy. For instance, in some examples, the computing device 112 and the computing device 114 are located in different server racks or different rooms that rely on different power supplies. Accordingly, if power is lost for the computing device 112, power may still remain for the second computing device 114. In other examples, computing devices 112, 114 are located remotely from low-side computing device 108 (e.g., in a different building or room).

The computing devices 112, 114 receive the data that is transmitted from the low-side computing device 108. Thus, in some examples, the computing device 112 may be referred to herein as a first receiving device 112, and the computing device 114 may be referred to herein as a second receiving device 114.

The unidirectional transfer of data from the low-side computing device 108 to the computing devices 112, 114 may be accomplished optically to add additional speed, reliability, and/or security to the data transfer. In the example depicted, the low-side computing device 108 includes an optical transmitter 109 that converts the segmented input data 110 into an optical signal that is transmitted into a first optical fiber 111. For instance, the optical transmitter 109 encodes the segmented input data 110 into a series of light pulses.

In general, fiber optic communication is a method of transmitting information from one location to another using light signals transmitted through optical fibers. Optical fibers are often be thin strands of glass or plastic that are designed to guide light along their length. Optical fibers provide many advantages including high speeds and the ability to transmit data with very little loss of signal strength. In addition, fiber optic communication is more secure than other forms of communication because it is difficult to intercept and tamper with the signals transmitted through optical fibers.

The optical transmitter 109 may be part of a transmit-only NIC or other circuit board that includes transmission-only capabilities. For instance, the circuit board may have no capability to receive optical data. In other examples, if the circuit board does include an optical receiver, no optical fiber from either of the receiving devices 112, 114 is connected to the receiver, and thus no data can be received by the optical receiver. For instance, a transmit-only NIC transmits data to an endpoint but cannot receive data from the endpoint due to the physical severing of the receive pin on the network controller chip of the transmit-only NIC. In some examples, the transmit-only NIC also includes firmware which sets the link state of the transmit-only NIC to always be “up” (e.g., enabled and/or active). In still other examples, a transmit-only circuit is formed by attached a splitter cable (e.g., y-splitter cable), where the transmission signal is split into two cables and one of the cables is directed back to the optical receiver of the transmitter circuit, which establishes a layer-1 link state and causes the circuit to sense a return data path even though no return data path actually exists. In yet other examples, a field-programmable gate array (FPGA) or similar device is configured to restrict data flow to be only unidirectional (e.g., transmit-only). Where the one-way communication is required by the physical components (rather than software-defined constraints), the one-way communication is considered to be physically enforced.

The optical signal generated from the optical transmitter 109 is then split by a beam splitter 117. The beam splitter 117 splits the optical signal (e.g., splits the light transmitted through the first optical fiber 111) into multiple optical signals. In the example depicted, the optical signal is split into two divided optical signals. One of the divided optical signals is passed into a first receiving optical fiber 119, and the other divided optical signal is passed into a second receiving optical fiber 121. Each of the divided optical signals replicate the original optical signal and therefore include the sample data as the original optical signal. While the optical signal is split into two optical signals in this example, the light may be split into additional signals in different examples.

The beam splitter 117 may be a passive splitter that is not required to be powered. For instance, when the light enters the beam splitter 117 from the first optical fiber 111, the light is split into the first receiving optical fiber 119 and the second receiving optical fiber 121 without the need for additional power. The beam splitter 117 utilizes reflective and/or refractive properties of its materials to cause the light to be split, such as by using two glass prisms that are adhered or otherwise connected to one another to create a partially reflective surface, a half-silvered mirror, a dichroic mirrored prism, or other suitable designs for splitting a beam of light.

By utilizing a passive beam splitter 117, additional reliability is also introduced into the system because the passive beam splitter 117 requires no power to operate. In some examples, the passive beam splitter 117 is positioned within the first computing environment 102 or the second computing environment 104. For instance, the beam splitter 117 may be a part of the low-side computing device 108 and/or part of the optical transmitter 109. In other examples, the beam splitter 117 is positioned in the second computing environment 104. For example, the beam splitter 117 may be incorporated into the first receiving device 112, the second receiving device 114, and/or another device of the second computing environment 104.

While the beam splitter 117 is primarily discussed herein as being a passive beam splitter, the beam splitter 117 may include other devices that split and/or duplicate the optical signals, and the beam splitter 117 may also be powered in some examples. For instance, the beam splitter 117 may include a switch with a Switched Port Analyzer (SPAN) port. the SPAN port creates a copy or duplicate of the data that can then be sent to another destination. As a result, a SPAN port may also be referred to as a mirror port in some examples. The duplicate is created by monitoring a source port and duplicating the data that is received on the source port. The beam splitter 117 may also be in the form of a Test Access Point (TAP). A TAP is a passive hardware device that splits or copies the data via beam splitter or passive optical coupler that splits the optical signals into two separate paths.

The divided optical signals are then received by the first receiving device 112 and the second receiving device 114 in parallel, respectively. More specifically, the divided optical signal propagating through the first receiving optical fiber 119 is received by a first optical receiver 113 of the first receiving device 112 that is coupled to the first receiving optical fiber 119. The divided optical signal propagating through the second receiving optical fiber 121 is received by a second optical receiver 115 of the second receiving device 114 coupled to the second receiving optical fiber 121. The optical receivers 113, 115 convert the optical signal into an electrical data signal that is the substantially the same as the electrical signal representing the segmented input data 110 that was provided to the optical transmitter 109. The electrical data signal representing the segmented input data 110 may then be processed by the first receiving device 112 and the second receiving device 114 as discussed herein.

Because the input data 110 that is transmitted from the first computing environment 102 to the second computing environment 104 is done so in a unidirectional manner, no acknowledgements, or requests for data to be resent, can be transmitted back to the first computing environment 102 from the second computing environment 104. For example, if the first receiving device 112 were to stop operating (e.g., system crash, power loss), the low-side computing device 108 would have no way of determining that first receiving device 112 is no longer functioning correctly” To help ensure that data received by the second computing environment 104 is handled and processed with a high fidelity, the first receiving device 112 and the second receiving device 114 provide data redundancy for the input data 110 that is transferred from the first computing environment 102 to the second computing environment 104. Thus, even if one of the first receiving device 112 or the second receiving device 114 becomes inoperable, the other device is still able to process the input data 110.

To provide such data redundancy, in the example depicted, the first receiving device 112 and the second receiving device 114 are in communication with one another, which may be bidirectional communication or unidirectional communication depending on the implementation. One type of data that is communicated is referred to as status data 116 or heartbeat data. The status data 116 indicates the health and/or status of the particular device from which it was sent. For example, status data 116 from the first receiving device 112 indicates the status or health of the first receiving device 112. Status data 116 from the second receiving device 114 indicates the status or health of the second receiving device 114. Thus, based on the status data 116, each of the first receiving device 112 and the second receiving device 114 is able to determine if the other device is functioning properly. The first receiving device 112 and/or the second receiving device 114 may use the status data 116 to change its operating state and determine which of the first receiving device 112 or the second receiving device 114 should be transmitting the input data 110 further through the system 100A.

In some examples, the status data 116 includes information about the performance of the device from which it sent, which may be general health data (e.g., uptime, processing speed, bandwidth utilization). Alternatively or additionally, the status data may include transmission information for one or more time periods. Examples of transmission information include the quantity of data transmitted during the time period, a list of data chunks and/or data segments transmitted for a file, a transaction identifier for each file transmitted, data transmission metrics (e.g., average/maximum time to transfer files or average/maximum file size), the number of data packets lost during transmission, the number of files for which error correction was performed, the success rate of performing error correction performed, and the current role or operating state of the computing device (e.g., primary device or secondary device).

The first receiving device 112 and the second receiving device 114 operate as either a primary device or a secondary device. The primary device transmits the received data further through the system. The secondary device does not transmit the received data further through the system. For instance, the secondary device may ultimately delete or discard the data it has received.

The designation of whether the first receiving device 112 or the second receiving device 114 is the primary device or the secondary device depends on the status data 116 and/or the input data 110 that is received by the first receiving device 112 and the second receiving device 114. In some examples, one of the receiving devices 112, 114 is designated as the primary device for all incoming data until that status data 116 indicates that the primary device is no longer functioning properly. For example, the first receiving device 112 may be initially designated as the primary device, and the second receiving device 114 may be designated as the secondary device.

In such examples, the first receiving device 112 retains its primary device operating status until the first receiving device 112 is no longer functioning or is no longer functioning correctly. In some examples, criteria for determining whether the first receiving device 112 is functioning correctly is based on the performance metrics of the first receiving device 112, which may be represented in the status data 116. For instance, the health data and/or transmission information may be compared to one or more thresholds to determine if the first receiving device 112 is functioning properly or within acceptable limits. If no status data 116 is received (e.g., due to the first receiving device being 112 down), the status data may be considered outside of the threshold and therefore indicate the non-functionality of the first receiving device 112. Such a determination may be made by the second receiving device 114 based on the status data 116 that is received from the first receiving device 112. Additionally or alternatively, if the second receiving device 114 does not receive status data 116 from the first receiving device 112 from within a timeout period (e.g., a set duration), the second receiving device 114 determines that the first receiving device 112 is not functioning properly.

When the second receiving device 114 determines that the first receiving device 112 is not functioning properly based on the status data 116 (or lack thereof), the second receiving device 114 changes its operating state from the secondary device to the primary device. If the first receiving device 112 is still partially operational, the second receiving device 114 may indicate the operating state change to the first receiving device 112 as part of the status data 116. When the second receiving device 114 is operating as the primary device, the second receiving device 114 transmits the data further through the system (e.g., towards the high-trust computing environment 106), and the first receiving device 112 does not further transmit the data.

While the second receiving device 114 is operating as the primary device, the second receiving device 114 continues to transmit status data 116 to the first receiving device 112. In examples where the first receiving device 112 is still operating (but at a degraded performance), the first receiving device 112 also continues transmitting the status data 116 to the second receiving device 114. In some examples, the second receiving device 114 continues to operate as the primary device even where the first receiving device 112 regains its proper or acceptable performance (as indicated by the status data). In such examples, the first receiving device 112 may transition back to the primary device when the status data 116 indicates that the second receiving device 114 is no longer functioning properly. The determination that the second receiving device 114 is not functioning properly may be similar to the determination relating to proper functioning of the first receiving device 112 discussed above. For instance, the first receiving device 112 may compare the status data 116 from the second receiving device 114 to one or more thresholds to determine if the second receiving device 114 is functioning properly.

In other examples, the second receiving device 114 may revert to the secondary device upon detecting that the first receiving device 112 has regained functionality. The first receiving device 112 then resumes its operating state as the primary device. For example, based on the status data 116, the second receiving device 114 may determine that the first receiving device 112 has resumed proper functionality. The second receiving device 114 may then transmit a message (e.g., as part of the status data 116) that indicates the first receiving device 112 is to resume operating as the primary device and the second receiving device 114 is switching its operating state to the secondary device.

In the example depicted, transmitting the data further through the system 100A includes transmitting the data to a guard 118, which may otherwise be referred to as a cross-domain protection device 118. The guard 118 protects the third computing environment 106 from data entering the third computing environment 106 from the second computing environment 104. The guard 118 may perform changes and/or checks to the data that is passed from the primary device. For instance, for a video stream, the guard 118 may transcode the video stream. Alternatively or additionally, the guard 118 may perform security checks or policy enforcement on the data to remove malicious data or remove any other types of data according to a policy set by the administrator of the third computing environment 106. For instance, in some examples, the guard 118 performs schema enforcement for data, such as data that is in an XML format.

If the data meets the criteria set forth by the guard 118, the guard 118 further transmits the data to a computing device 120 of the third computing environment 106. The computing device 120 may be referred to as a high-side computing device 120 where the third computing environment 106 has higher security requirements than the second computing environment 104 and/or the first computing environment 102. The high-side computing device 120 may further process the data that is received from the second computing environment 104, and/or the high-side computing device 120 may transfer the data to the data storage device 122 of the third computing environment 106 for later access of other computing devices in the third computing environment 106. Examples of data storage device 122 include direct-attached storage devices (e.g., hard drives, solid-state drives, and optical disk drives), network-based storage devices (e.g., storage area network (SAN) devices and network-attached storage (NAS) devices), and other types of memory devices.

FIG. 1B depicts another example system 100B that includes two guards 118A-118B rather than a single guard 118. Other than the multiple guards 118A-B, the system 100B is substantially similar to the system 100A depicted in FIG. 1A.

The system 100B provides additional reliability due to the redundancy of the guards 118A-118B. For instance, if one of the guards becomes inoperative, the other guard may still be utilized. In the example depicted, the first receiving device 112 is in communication with a first guard 118A, and the second receiving device 114 is in communication with a second guard 118B. Accordingly, when the first receiving device 112 is operating as the primary device, the first receiving device 112 transmits data to the first guard 118A. Similarly, when the second receiving device 114 is operating as the primary device, the second receiving device 114 transmits data to the second guard 118B.

The functionality of the guards 118A-118B may be considered in combination with the functionality of the first receiving device 112 and the second receiving device 114 when determining which of the first receiving device 112 or the second receiving device 114 should be operating as the primary device. For instance, in some examples, the status data 116 that is exchanged between the receiving devices 112, 114 also includes performance, health, and/or transmission data for the corresponding guards 118A-118B as well. As an example, the status data 116 transmitted by the first receiving device 112 also includes status data for the first guard 118A. Similarly, the status data 116 transmitted by the second receiving device 114 may also include status data for the second guard 118B.

The determination of which receiving device is to operate as the primary device or the secondary device may then be based on the combined status data from respective received device and guard. For instance, in the example where the first receiving device 112 starts as the primary device, the determination as to proper functionality is based on the status data for the first receiving device 112 and the first guard 118A. Accordingly, if either the first receiving device 112 or the first guard 118A are no longer functioning properly, the second receiving device 114 becomes the primary device and the first receiving device 112 becomes the secondary device. Similarly, while the second receiving device 114 is the primary device, an indication that that either the second receiving device 114 or the second guard 118B is no longer functioning properly results in the first receiving device 112 becoming the primary device and the second receiving device 114 becoming the secondary device.

In other examples, the first receiving device 112 and/or the second receiving device 114 may be in communication with both guards 118A-B. In such examples, when one of guards 118A-B becomes nonfunctional, the first receiving device 112 and/or the second receiving device 114 may direct traffic (e.g., send the data) to the remaining functioning guard. Such information regarding the health of the guards 118A-B may still be transmitted as part of the status data 116.

FIG. 1C depicts another example system 100C that includes multiple transmitting or low-side computing devices 108A-B. The introduction of multiple transmitting devices 108A-B also introduces additional fiber optic components. Other than those differences, the system 100C is substantially similar to the system 100B discussed above with reference to FIG. 1B.

The first transmitting device 108A and its connections are substantially similar to the transmitting device 108 discussed above. For instance, the first transmitting computing device 108A receives first input data 110A. The first input data 110A is transmitted optically to the second computing environment 104. The receiving devices 112, 114 receive the first data that is transmitted from the first transmitting computing device 108A.

In the example depicted, the first transmitting device 108A includes a first optical transmitter 109A that converts the first input data 110A into an optical signal that is transmitted into a first optical fiber 111A. The optical signal generated from the first optical transmitter 109A is then split by a first beam splitter 117A. The first beam splitter 117A splits the optical signal (e.g., splits the light transmitted through the first optical fiber 111A) into multiple optical signals. One of the divided optical signals is passed into a first receiving optical fiber 119A, and the other divided optical signal is passed into a second receiving optical fiber 121A. The divided optical signal propagating through the first receiving optical fiber 119A is then received by the first optical receiver 113 of the first receiving device 112, and the divided optical signal propagating through the second receiving optical fiber 121A is received by a second optical receiver 115 of the second receiving device 114. Thus, both the first receiving device 112 and the second receiving device 114 receive the first input data 110A.

The second transmitting device 108B and its connections may operate in a similar manner as the first transmitting device 108A. For instance, the second transmitting device 108B receives second input data 110B. The second input data 110B is similarly transmitted optically to the second computing environment 104, and the receiving devices 112, 114 receive the second input data 110B that is transmitted from the second transmitting computing device 108B.

In the example depicted, the second transmitting device 108B includes a second optical transmitter 109B that converts the second input data 110B into an optical signal that is transmitted into an optical fiber 111B. The optical signal generated from the second optical transmitter 109B is then split by a second beam splitter 117B. The second beam splitter 117B splits the optical signal (e.g., splits the light transmitted through the optical fiber 111B) into multiple optical signals. One of the divided optical signals is passed into a third receiving optical fiber 119B, and the other divided optical signal is passed into a fourth receiving optical fiber 121B. The divided optical signal propagating through the third receiving optical fiber 119B is then received by the first optical receiver 113 of the first receiving device 112, and the divided optical signal propagating through the fourth receiving optical fiber 121B is received by the second optical receiver 115 of the second receiving device 114. Thus, both the first receiving device 112 and the second receiving device 114 receive the second input data 110B.

In some examples, the transmitting devices 108A-B may be located in the same facility and/or same server rack. The first receiving device 112 and the second receiving device 114, however, are generally not located within the same server rack as the transmitting devices 108A-B. In addition, the first receiving device 112 and the second receiving device 114 are also provided in separate server racks to help ensure the reliability and redundancy goals of the two receiving devices 112, 114.

In some examples, the designation of the primary device and the secondary device for the first receiving device 112 and the second receiving device 114 is based on the source of the data that is received and processed. For example, initially or by default, the first receiving device 112 may be the primary device for the data sent from the first transmitting device 108A (e.g., the first input data 110A). Similarly, the second receiving device 114 may be initial or default primary device for data sent from the second transmitting device 108B (e.g., the second data 110B.) Accordingly, when both the first receiving device 112 and the second receiving device 114 are functioning at acceptable levels, both the first receiving device 112 and the second receiving device 114 are transmitting data further through the system 100C towards the high-trust computing environment 106 (e.g., to the first guard 118A and/or the second guard 118B). For instance, the first receiving device 112 transmits the first input data 110A to the first guard 118A, and the second receiving device 114 transmits the second input data 110B to the second guard 118B.

To make the decision as to whether the received data should be transmitted or dropped (e.g., deleted or otherwise not forwarded/transmitted), the first receiving device 112 and the second receiving device 114 inspect the incoming data for the source identification or address (e.g., source address in a packet or datagram header). If the source identification or address matches a source address or identification for which the first receiving device 112 or the second receiving device 114 is the primary device, then the corresponding receiving device transmits or forwards the corresponding data. For instance, where the first receiving device 112 is the primary device for data received from the first transmitting device 108A, the first receiving device 112 processes and transmits the data having a source address corresponding to the first transmitting device 108A. The first receiving device 112 then drops the data having a source address corresponding to the second transmitting device 108B. In examples where the second receiving device 114 is the primary device for data received from the second transmitting device 108B, the second receiving device 114 processes and transmits data having a source address corresponding to the second transmitting device 108B. The second receiving device 114 then drops the data having a source address corresponding to the first transmitting device 108A.

In some examples, the receiving devices 112, 114 is designated as the primary device or the secondary device based on other designations, such as a type of file or for a particular account. For instance, the receiving devices 112, 114 may be designated as the primary device or the secondary device based on an identifier, such as globally unique identifier (GUID), of the data. In such examples, the receiving devices 112, 114 inspect or analyze the identifier of the received data to determine if the receiving device is to act as a primary device or a secondary device for the specific data. For instance, the receiving devices 112, 114 may compare the identifier to a stored table that indicates identifiers for which each receiving device is considered the primary device or the secondary device.

Similar to the examples described above with respect to FIG. 1A, the designation of primary device and secondary device may change based on the functionality of the first receiving device 112 and the second receiving device 114, which may be determined from the status data 116 exchanged between the first receiving device 112 and the second receiving device 114. As an example, the first receiving device 112 is operating as the primary device, for data from the first transmitting device 108A, and the secondary device for data from the second transmitting device 108B. If the second receiving device 114 then becomes inoperable or non-functioning, the first receiving device 112 also becomes the primary device for data from the second transmitting device 108B. Thus, when the first receiving device 112 becomes the primary device for data coming from both the first transmitting device 108A and the second transmitting device 108B, the first receiving device 112 transmits the data from both transmitting devices 108A-B to the first guard 118A.

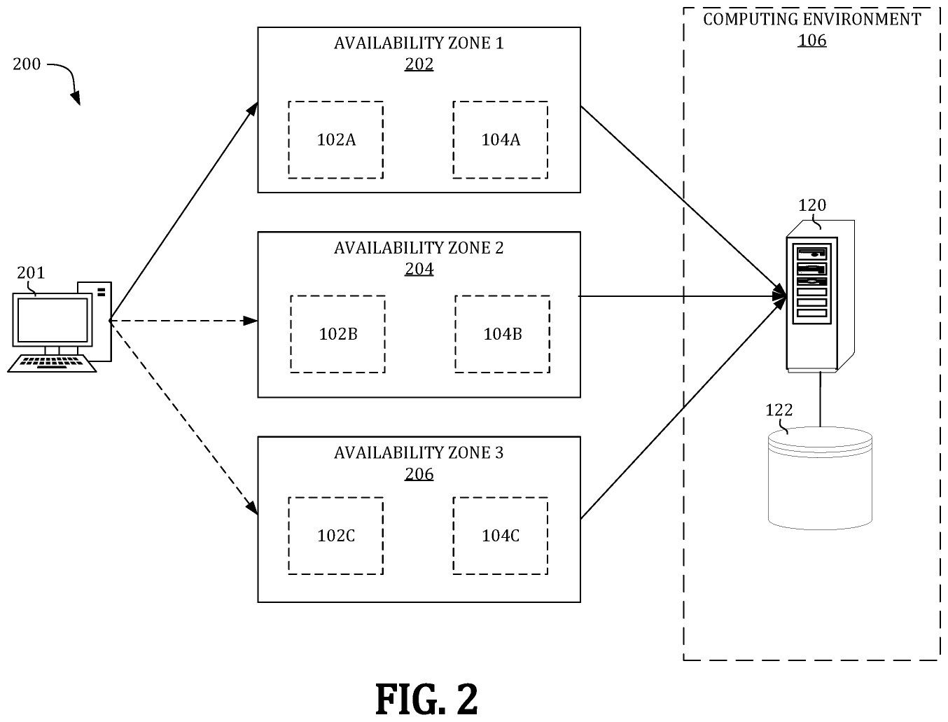

FIG. 2 depicts an example one-way transfer (OWT) system 200 with multiple availability zones 202-206. Each availability zone provides additional redundancy and reliability enhancements in addition to the enhancements discussed above. For example, in the examples discussed above, both transmitting devices and/or the receiving devices may all be located within the same facility. If the entire facility stops functioning (e.g., due to catastrophic damage or loss of power), all the devices in that facility stop functioning, resulting in a system failure. The system 200 introduces multiple availability zones that provide additional availability even when an entire facility fails.

In the example depicted, the system 200 includes a first availability zone 202, a second availability zone 204, and a third availability zone 206. Each availability zone 202-206 may represent a different geographic location, facility, building, etc. Each of the availability zones includes a first computing environment 102 (e.g., low-trust computing environment 102) and a second computing environment 104 (e.g., middle-security or middle-trust environment 104), that may be substantially similar to the first computing environment 102 and the second computing environment 104, respectively, described above.

In examples, each of the first/low-trust computing environments 102 include one or more transmitting devices and fiber optic components discussed above, and each of the second/middle-trust computing environments may include one or more receiving devices and guards. For example, the first availability zone 202 includes a first low-trust environment 102A and a first middle-trust environment 104A, the second availability zone 204 includes a second low-trust computing environment 102B and a second middle-trust environment 104B, and the third availability zone 206 includes a third low-trust environment 102C and a first middle-trust environment 104C.

Each of the availability zones 202-206 are also in communication with the third computing environment 106 (e.g., high-trust computing environment 106). For instance, the guards within the availability zones 202-206 are capable of transmitting data to the high-side computing device 120.

In the system 200, an originating device 201 is attempting to send data to the high-side computing environment 106 (e.g., to the high-side computing device 120 or the data storage device 122.) One of availability zones 202-206 may be considered the primary zone for the originating device 201. As an example, the first availability zone 202 is considered the initial or default primary zone for the originating device 201. If the first availability zone 202 becomes nonfunctional, either the second availability zone 204 or the third availability zone 206 becomes the primary zone for the originating device 201, and traffic from the originating device 201 is routed or directed to the newly designated primary zone. The indication of which availability zone 202-206 is currently the primary zone (and where traffic should be directed) may be communicated to the originating device 201 and/or incorporated into orchestration data, routing tables, etc.

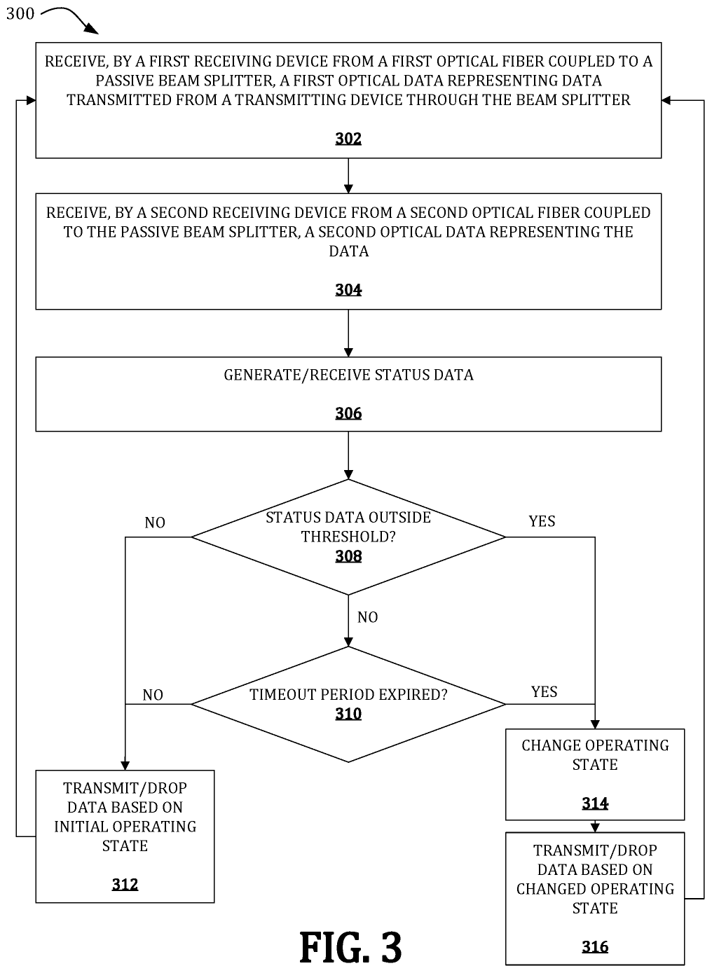

FIG. 3 depicts an example method 300 for operating fault-tolerant data diodes in one-way transfer systems. The method 400 may be performed by one or more of the devices discussed above, such as the devices within systems 100A-C and/or system 200. For example, the method may be performed by one of the first receiving device 112 and/or the second receiving device 114.

At operation 302, a first receiving device receives first optical data. The first optical data is received from a first optical fiber that is coupled to a passive beam splitter. The first optical data represents data that is transmitted from a transmitting device through the beam splitter.

At operation 304, a second receiving device receives second optical data. The second optical data is received from a second optical fiber that is coupled to the same passive beam splitter as the first optical fiber. The second optical data is the same or substantially the same as the first optical data and also represents the data the is transmitted from the transmitting device through the beam splitter.

At operation 306, the status data is generated and exchanged between the receiving devices. For instance, the first receiving device generates and transmits status data that is received by the second receiving device. The second receiving device generates and transmits status data that is received by the first receiving device. The received status data may then be analyzed and the operational state may be changed based on the analysis of the status data. For the sake of clarity, the following example is described where the first receiving device is initially the primary device, and the second receiving device is the secondary device. However, other examples are possible where the initial operating states of the receiving devices are switched.

At determination 308, the received status data is compared to a functionality threshold. For instance, the health data and/or transmission information in the received status data is compared to one or more functionality thresholds to determine if the device that generated the status data is functioning properly or within acceptable levels. As an example, the second receiving device analyzes the status data from the first receiving device to determine if the first receiving device is functioning properly. For instance, the second receiving device may determine whether the status data from the first receiving device is outside of the functionality threshold (e.g., indicating poor functionality of the first receiving device).

If the status data is outside of the functionality threshold, the method 300 flows to operation 314 where the operating state of the second receiving device is changed from being the secondary device to being the primary device. At operation 316, the data is transmitted based on the changed operating state. For instance, the second receiving device transmits the data because its operating state has been changed to be the primary device. The first receiving device (to the extent it is still operational) drops the data. In examples where the first receiving device is not operational (e.g., due to a power loss), the data is automatically dropped as the optical signal is never processed or converted by the first receiving device.

If, at determination 308, the status data is within the functionality threshold (e.g., indicating the first receiving device is functioning properly), the method 300 flows to operations 310 and 312. At operation 312, the data is transmitted based on the initial or previous operating states of the receiving devices. In the present example, the first receiving device transmits the data because it is the primary device, and the second receiving device drops the data because it is the secondary device.

In some examples, the secondary device retains an amount of the data before it is dropped. For example, where the data represents a file or another discrete, known amount of data, the secondary device may retain the data until the primary device indicates that the entire file or data has been successfully transmitted. In other examples, where the data represents an unknown total amount of data (e.g., a stream of feed of data), the secondary device may retain a predefined amount of data, such as within a buffer or temporary memory of the secondary device. The retained data may then be dropped after a period of time or after a confirmation form the primary device that the same data has been successfully transmitted by the primary device.

At operation 310, a determination is made as to whether a timeout period has expired before receiving second or subsequent status data. For instance, the second receiving device may determine whether the subsequent status data has been received from the first receiving device prior to the expiration of the timeout period. If the timeout period has not expired before receiving the subsequent status data, the method 300 flows to operation 312 where the data continues to be transmitted/dropped according to the prior or initial operating states. If the timeout period has expired, the method 300 flows to operation 314 and then operation 316. Operations 314 and 316 are performed as discussed above. The method 300 may then flow back to operation 302 where the method repeats for new data received from the transmitting device.

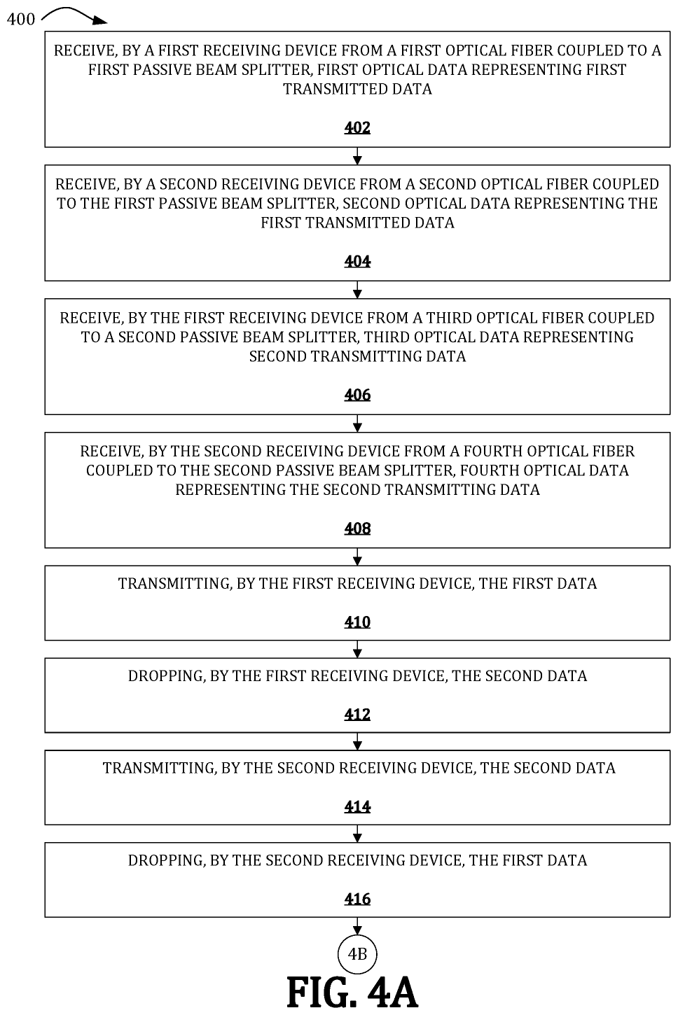

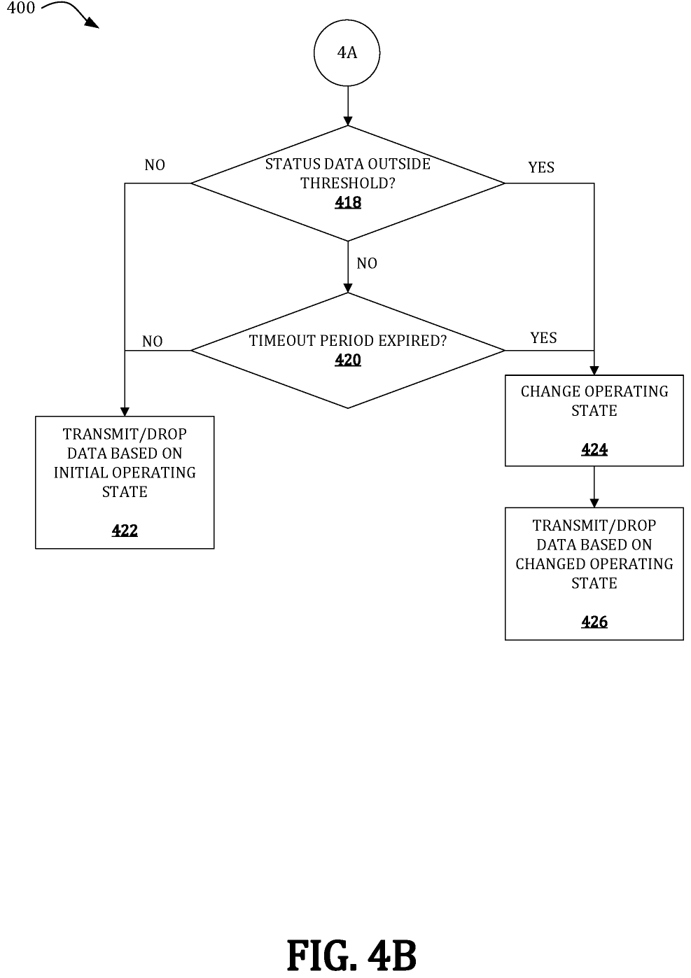

FIGS. 4A-B depict another example method 400 for operating fault-tolerant data diodes in one-way transfer systems. The method 400 may be performed by one or more of the devices discussed above, such as the devices within systems 100A-C and/or system 200. For example, the method may be performed by one of the first receiving device 112 and/or the second receiving device 114.

At operation 402, a first receiving device receives first optical data. The first optical data is received from a first optical fiber coupled to a first passive beam splitter. The first optical data represents first data transmitted from a first transmitting device through the first passive beam splitter.

At operation 404, a second receiving device receives second optical data. The second optical data is received from a second optical fiber coupled to the first passive beam splitter. The second optical data is the same or substantially the same as the first optical data and also represents the first data that is transmitted from the first transmitting device through the first beam splitter.

At operation 406, the first receiving device receives third optical data. The third optical data is received from a third optical fiber that is coupled to a second passive beam splitter. The third optical data represents second data transmitted from a second transmitting device through the second passive beam splitter.

At operation 408, the second receiving device receives fourth optical data. The fourth optical data is received from a fourth optical fiber that is coupled to the second passive beam splitter. The fourth optical data is the same or substantially the same as the third optical data and also represents the second data that is transmitted from the second transmitting device through the second beam splitter.

In the initial receipt of the respective data, the receiving devices transmit/drop data according to the default, initial, or current operating states of the receiving devices. In the example used below, the first receiving device initially operates as the primary device for the first data received from the first transmitting device, and the second receiving device initially operates as the primary device for the second data received from the second transmitting device. Accordingly, prior to further transmitting or dropping the data, the receiving devices inspect or analyze the source identification and/or address of the data to determine if the receiving device is to act as a primary device or a secondary device for the specific data. For instance, the receiving devices may compare the source address to a stored table that indicates source addresses for which each receiving device is considered the primary device or the secondary device.

In some examples, the receiving devices may be designated as the primary device or the secondary device based on other designations, such as a type of file or for a particular account. For instance, the receiving devices may be designated as the primary device or the secondary device based on an identifier, such as globally unique identifier (GUID), of the data. In such examples, the receiving devices inspect or analyze the identifier of the received data to determine if the receiving device is to act as a primary device or a secondary device for the specific data. For instance, the receiving devices may compare the identifier to a stored table that indicates identifiers for which each receiving device is considered the primary device or the secondary device.

At operation 410, the first receiving device transmits the first data based on determining that the first data has a source address corresponding to the first transmitting device or an identifier of the first data indicates that the first receiving device is the primary device for the first data. The first data may be transmitted to a first guard.

At operation 412, the first receiving device drops the second data based on determining that the second data has a source address corresponding to the second transmitting device or an identifier of the second data indicates that the first receiving device is the secondary device for the second data. The second data may be stored by the first receiving device until an indication is received from the second receiving device that the second data has been successfully transmitted by the second receiving device. The indication may be provided as part of the status data.

At operation 414, the second receiving device transmits the second data based on determining that the second data has a source address corresponding to the second transmitting device or an identifier of the second data indicates that the second receiving device is the primary device for the second data. The second data may be transmitted to a second guard.

At operation 416, the second receiving device drops the first data based on determining that the first data has a source address corresponding to the first transmitting device or an identifier of the first data indicates that the second receiving device is the secondary device for the first data. The first data may be stored by the second receiving device until an indication is received from the first receiving device that the first data has been successfully transmitted by the first receiving device. The indication may be provided as part of the status data.

At operation 418, the received status data is compared to a functionality threshold. For instance, the health data and/or transmission information in the received status data is compared to one or more functionality thresholds to determine if the device that generated the status data is functioning properly or within acceptable levels. As an example, the second receiving device analyzes the status data from the first receiving device to determine if the first receiving device is functioning properly. For instance, the second receiving device may determine whether the status data from the first receiving device is outside of the functionality threshold (e.g., indicating poor functionality of the first receiving device).

If the status data is outside of the functionality threshold, the method 400 flows to operation 424 where the operating state of the second receiving device is changed from being the secondary device, for the first transmitting device, to being the primary device for the first transmitting device. In other words, the second receiving device takes over as the primary device for the data that the first receiving device was previously operating as the primary device. For instance, the second receiving device may now act as the primary receiving device for data having an identifier for which the first receiving device was previously the primary device.

At operation 426, the data is transmitted based on the changed operating state. For instance, the second receiving device transmits the first data and the second data (e.g., data from both the first and second transmitting devices) because its operating state has been changed to be the primary device. The first receiving device (to the extent it is still operational) drops the first data and the second data. In examples where the first receiving device is not operational (e.g., due to a power loss), the first data and the second data are automatically dropped because the optical signal is never processed or converted by the first receiving device.

If, at determination 418, the status data is within the functionality threshold (e.g., indicating the first receiving device is functioning properly), the method 400 may flow to operations 420 and/or 422. At operation 422, the data is transmitted based on the initial operating states of the receiving devices. In the present example, the first receiving device transmits the first data because it is the primary device for the first transmitting device, and the second receiving device drops the first data because it is the secondary device. Similarly, the second receiving device transmits the second data because it is the primary device for the second transmitting device, and the first receiving device drops the second data because it is the secondary device for the second transmitting device.

At operation 420, a determination is made as to whether a timeout period has expired before receiving second or subsequent status data. For instance, the second receiving device may determine whether the subsequent status data has been received from the first receiving device prior to the expiration of the timeout period. If the timeout period has not expired before receiving the subsequent status data, the method 400 flows to operation 422 where the data continues to be transmitted/dropped according to the prior or initial operating states. If the timeout period has expired, the method 400 flows to operation 424 and then operation 426. Operations 424 and 426 are performed as discussed above. The method 400 may then flow back to operation 402 where the method repeats for new data received from the transmitting device.

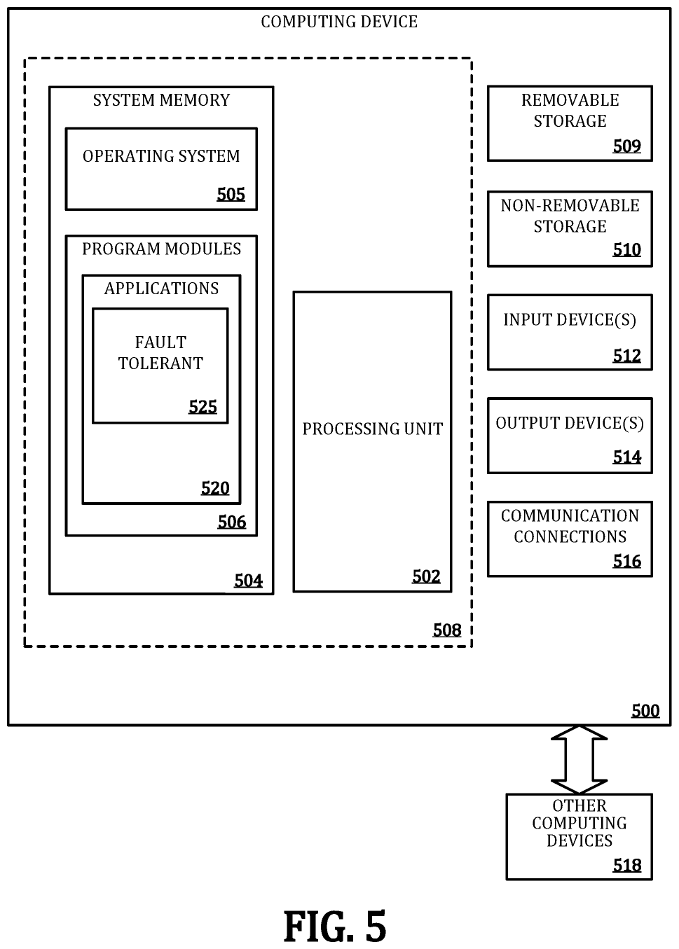

FIG. 5 is a block diagram illustrating physical components (e.g., hardware) of a computing device 500 with which aspects of the disclosure may be practiced. The computing device components described below may be suitable for the computing devices and systems described above. In a basic configuration, the computing device 500 includes at least one processing unit 502 and a system memory 504. Depending on the configuration and type of computing device, the system memory 504 may comprise volatile storage (e.g., random access memory (RAM)), non-volatile storage (e.g., read-only memory (ROM)), flash memory, or any combination of such memories.

The system memory 504 includes an operating system 505 and one or more program modules 506 suitable for running software applications 520, such as one or more components supported by the systems described herein. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, or optical disks. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., applications 520) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc. For instance, the applications 520 may include a fault-tolerant application 525 that performs the operations discussed herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

As should be appreciated from the foregoing discussion, in an aspect, the technology relates to a one-way transfer (OWT) system including a transmitting computing device, located in a source computing environment, comprising an optical transmitter that transmits optical signals corresponding to data transmitted by the transmitting computing device; a beam splitter that splits or duplicates the optical signals from the optical transmitter into a first optical fiber and a second optical fiber; a first receiving device comprising a first optical receiver, coupled to the first optical fiber, that converts the optical signal from the first optical fiber into a first electrical data signal representing the data transmitted by the transmitting computing device; and a second receiving device comprising a second optical receiver, coupled to the second optical fiber, that converts the optical signal from the second optical fiber into a second electrical data signal representing the data transmitted by the transmitting computing device. While the first receiving device is functioning within a functionality threshold: the first receiving device operates as a primary device and transmits the data, received from the first optical fiber, towards a destination computing environment; and the second receiving device operates as a secondary device and drops the data received from the second optical fiber. While the first receiving device is functioning outside the functionality threshold: the first receiving device operates as the secondary device and drops the data received from the first optical fiber; and the second receiving device operates as the primary device and transmits the data, received from the second optical fiber, towards the destination computing environment.

In another aspect, the technology relates to a one-way transfer (OWT) system including a transmitting computing device, located in a source computing environment, comprising an optical transmitter that transmits optical signals corresponding to data transmitted by the transmitting computing device; a beam splitter that splits or duplicates the optical signals from the optical transmitter into a first optical fiber and a second optical fiber; a first receiving device comprising a first optical receiver, coupled to the first optical fiber, that converts the optical signal from the first optical fiber into a first electrical data signal representing the data transmitted by the transmitting computing device; and a second receiving device comprising a second optical receiver, coupled to the second optical fiber, that converts the optical signal from the second optical fiber into an electrical data signal representing the data transmitted by the transmitting computing device, the second receiving device comprising memory and instructions stored in memory that when executed perform operations. The operations include operating as a secondary device, while the first receiving device operates as a primary device, by dropping the data received from the second optical fiber; and in response to the first receiving device functioning outside a functionality threshold, operating as the primary device by transmitting the data received from the second optical fiber toward a destination computing environment.

In an example, the system further includes at least one of: a first guard in communication with the first receiving device and a device of the destination computing environment; and a second guard in communication with the second receiving device and the device of the destination computing environment. In a further example, the source computing environment is a low-trust computing environment with respect to the destination environment which is a high-trust environment. In another example, the first receiving device: generates first status data regarding performance of the first receiving device; and transmits the status data to the second receiving device; and the second receiving device: receives the first status data; generates second status data regarding performance of the second receiving device; and transmits the second status data to the first receiving device. In yet another example, the transmitting computing device is positioned on a first server rack and the first receiving device is positioned on a second server rack different from the first server rack.

In another example, the transmitting computing device is a first transmitting computing device, the beam splitter is a first beam splitter, the optical transmitter is a first optical transmitter, and the system further includes a second transmitting computing device, located in the source computing environment, comprising a second optical transmitter that transmits optical signals corresponding to data transmitted by the second transmitting computing device; a third optical fiber coupled to the first optical receiver of the first receiving device; a fourth optical fiber coupled to the second optical receiver of the second receiving device; and a second beam splitter that splits or duplicates the optical signals from the second optical transmitter into the third optical fiber and the fourth optical fiber. In a further example, the first transmitting device and the second transmitting computing device are positioned in the same server rack. In yet another example, the optical transmitter is a transmit-only device, and the transmitting device does not receive data from the first receiving device or the second receiving device.

In another aspect, the technology relates to a computer-implemented method for operating a fault-tolerant data diode in a one-way transfer system. The method includes receiving, by a first receiving device from a first optical fiber coupled to a beam splitter, first optical data representing data transmitted from a transmitting device through the beam splitter; receiving, by a second receiving device from a second optical fiber coupled to the beam splitter, second optical data representing the data; receiving, by the second receiving device from the first receiving device at a first point in time, first status data representing performance of the first receiving device; based on at least one of: (1) the first status data or (2) not receiving second status data within a timeout period after the first point in time: changing an operating state of the second receiving device to be a primary device for transmitting the received optical data; and changing an operating state of the first receiving device to be a secondary device and drop the received optical data; and while the second receiving device is in the primary-device operating state, transmitting the data by the second receiving device.

In an example, the second receiving device transmits the data to a cross-domain protection device that performs policy enforcement for a computing environment. In another example, the method further includes receiving, by the first receiving device from the second receiving device at a second point in time after the first point in time, second status data representing performance of the second receiving device; based on at least one of: (1) the second status data or (1) not receiving third status data from the second receiving device within a timeout period after the second point in time: changing the operating state of the first receiving device to be the primary device for transmitting the received optical data; and changing the operating state of the second receiving device to be the secondary device configured to drop the received optical data. In still another example, the first status data includes transmission information relating to at least one of: a quantity of data transmitted during the time period, a list of data transmitted, data transmission metrics, or a number of data packets lost during transmission, a success rate of performing error correction performed. In a further example, the first status data indicates that the operating state of the first receiving device is the primary device. In yet another example, the second status data indicates that the operating state of the second receiving device is the primary device.

In another aspect, the technology relates to a computer-implemented method for operating a fault-tolerant data diode in a one-way transfer system. The method includes receiving, by a first receiving device from a first optical fiber coupled to a first passive beam splitter, first optical data representing first data transmitted from a first transmitting device through the first passive beam splitter; receiving, by a second receiving device from a second optical fiber coupled to the first passive beam splitter, second optical data representing the first data; receiving, by the first receiving device from a third optical fiber coupled to a second passive beam splitter, third optical data representing second data transmitted from a second transmitting device through the second passive beam splitter; receiving, by the second receiving device from a fourth optical fiber coupled to the second passive beam splitter, fourth optical data representing the second data; at a first point in time, based on the first receiving device being in an operating state as a primary device for the first transmitting device and a secondary device for the second transmitting device: transmitting, by the first receiving device, the first data; and dropping, by the first receiving device, the second data; at the first point in time, based on the second device being in an operating state as a primary device for the second transmitting device and a second device for the first transmitting device: transmitting, by the second receiving device, the second data; and dropping, by the second receiving device, the first data.

In an example, the method further includes receiving, by the second receiving device at a second point in time, status data from the first transmitting device; determining, by the second receiving device, that the status data is outside a functionality threshold; based on the status data being outside the functionality threshold, changing the operating state of the second receiving device to be the primary device for the first transmitting device and the second transmitting device. In another example, the method further includes determining, by the second receiving device at a second point in time, that status data from the first receiving device has not been received within a timeout period; and based on determining that the status data has not been received within the timeout period, changing the operating state of the second receiving device to be the primary device for the first transmitting device and the second transmitting device. In still another example, the first receiving device is positioned with a first server rack and the second receiving device is positioned in a second server rack different from the first server rack. In yet another example, the first receiving device transmits the first data to a first guard that provides policy enforcement for a high-trust computing environment; and the second receiving device transmits the second data to a second guard that provides policy enforcement for the high-trust computing environment. In still yet another example, the first receiving device and the second receiving device cannot transmit data to the first transmitting device or the second transmitting device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A one-way transfer (OWT) system comprising:
a transmitting computing device, located in a source computing environment, comprising an optical transmitter that transmits optical signals corresponding to data transmitted by the transmitting computing device;
a beam splitter that splits or duplicates the optical signals from the optical transmitter into a first optical fiber and a second optical fiber;
a first receiving device comprising a first optical receiver, coupled to the first optical fiber, that converts the optical signal from the first optical fiber into a first electrical data signal representing the data transmitted by the transmitting computing device; and
a second receiving device comprising a second optical receiver, coupled to the second optical fiber, that converts the optical signal from the second optical fiber into an electrical data signal representing the data transmitted by the transmitting computing device, the second receiving device comprising memory and instructions stored in memory that when executed perform operations comprising:
operating as a secondary device, while the first receiving device operates as a primary device, by dropping the data received from the second optical fiber; and
in response to the first receiving device functioning outside a functionality threshold, operating as the primary device by transmitting the data received from the second optical fiber toward a destination computing environment.

2. The OWT system of claim 1, further comprising at least one of:
a first guard in communication with the first receiving device and a device of the destination computing environment; and
a second guard in communication with the second receiving device and the device of the destination computing environment.

3. The OWT system of claim 2, wherein the source computing environment is a low-trust computing environment with respect to the destination environment which is a high-trust environment.

4. The OWT system of claim 1, wherein:
the first receiving device:
generates first status data regarding performance of the first receiving device; and
transmits the status data to the second receiving device;
the second receiving device:
receives the first status data;
generates second status data regarding performance of the second receiving device; and
transmits the second status data to the first receiving device.

5. The OWT system of claim 1, wherein the transmitting computing device is positioned on a first server rack and the first receiving device is positioned on a second server rack different from the first server rack.

6. The OWT system of claim 1, wherein the transmitting computing device is a first transmitting computing device, the beam splitter is a first beam splitter, the optical transmitter is a first optical transmitter, and the system further comprises:
a second transmitting computing device, located in the source computing environment, comprising a second optical transmitter that transmits optical signals corresponding to data transmitted by the second transmitting computing device;
a third optical fiber coupled to the first optical receiver of the first receiving device;
a fourth optical fiber coupled to the second optical receiver of the second receiving device; and
a second beam splitter that splits or duplicates the optical signals from the second optical transmitter into the third optical fiber and the fourth optical fiber.

7. The OWT system of claim 6, wherein the first transmitting device and the second transmitting computing device are positioned in the same server rack.

8. The OWT system of claim 1, wherein the optical transmitter is a transmit-only device, and the transmitting device does not receive data from the first receiving device or the second receiving device.

9. A computer-implemented method for operating a fault-tolerant data diode in a one-way transfer system, the method comprising:
receiving, by a first receiving device from a first optical fiber coupled to a beam splitter, first optical data representing data transmitted from a transmitting device through the beam splitter;
receiving, by a second receiving device from a second optical fiber coupled to the beam splitter, second optical data representing the data;
receiving, by the second receiving device from the first receiving device at a first point in time, first status data representing performance of the first receiving device;
based on at least one of: (1) the first status data or (2) not receiving second status data within a timeout period after the first point in time:
changing an operating state of the second receiving device to be a primary device for transmitting the received optical data; and
changing an operating state of the first receiving device to be a secondary device and drop the received optical data; and
while the second receiving device is in the primary-device operating state, transmitting the data by the second receiving device.

10. The computer-implemented method of claim 9, wherein the second receiving device transmits the data to a cross-domain protection device that performs policy enforcement for a computing environment.

11. The computer-implemented method of claim 9, further comprising:
receiving, by the first receiving device from the second receiving device at a second point in time after the first point in time, second status data representing performance of the second receiving device;
based on at least one of: (1) the second status data or (1) not receiving third status data from the second receiving device within a timeout period after the second point in time:
changing the operating state of the first receiving device to be the primary device for transmitting the received optical data; and
changing the operating state of the second receiving device to be the secondary device configured to drop the received optical data.

12. The computer-implemented method of claim 9, wherein the first status data includes transmission information relating to at least one of: a quantity of data transmitted during the time period, a list of data transmitted, data transmission metrics, or a number of data packets lost during transmission, a success rate of performing error correction performed.

13. The computer-implemented method of claim 12, wherein the first status data indicates that the operating state of the first receiving device is the primary device.

14. The computer-implemented method of claim 13, wherein the second status data indicates that the operating state of the second receiving device is the primary device.

15. A computer-implemented method for operating a fault-tolerant data diode in a one-way transfer system, the method comprising:
receiving, by a first receiving device from a first optical fiber coupled to a first passive beam splitter, first optical data representing first data transmitted from a first transmitting device through the first passive beam splitter;
receiving, by a second receiving device from a second optical fiber coupled to the first passive beam splitter, second optical data representing the first data;
receiving, by the first receiving device from a third optical fiber coupled to a second passive beam splitter, third optical data representing second data transmitted from a second transmitting device through the second passive beam splitter;
receiving, by the second receiving device from a fourth optical fiber coupled to the second passive beam splitter, fourth optical data representing the second data;
at a first point in time, based on the first receiving device being in an operating state as a primary device for the first transmitting device and a secondary device for the second transmitting device:
transmitting, by the first receiving device, the first data; and
dropping, by the first receiving device, the second data;
at the first point in time, based on the second device being in an operating state as a primary device for the second transmitting device and a second device for the first transmitting device:
transmitting, by the second receiving device, the second data; and
dropping, by the second receiving device, the first data.

16. The computer-implemented method of claim 15, further comprising:
receiving, by the second receiving device at a second point in time, status data from the first transmitting device;
determining, by the second receiving device, that the status data is outside a functionality threshold;
based on the status data being outside the functionality threshold, changing the operating state of the second receiving device to be the primary device for the first transmitting device and the second transmitting device.

17. The computer-implemented method of claim 15, further comprising:
determining, by the second receiving device at a second point in time, that status data from the first receiving device has not been received within a timeout period; and
based on determining that the status data has not been received within the timeout period, changing the operating state of the second receiving device to be the primary device for the first transmitting device and the second transmitting device.

18. The computer-implemented method of claim 15, wherein the first receiving device is positioned with a first server rack and the second receiving device is positioned in a second server rack different from the first server rack.

19. The computer-implemented method of claim 15, wherein:
the first receiving device transmits the first data to a first guard that provides policy enforcement for a high-trust computing environment; and
the second receiving device transmits the second data to a second guard that provides policy enforcement for the high-trust computing environment.

20. The computer-implemented method of claim 15, wherein the first receiving device and the second receiving device cannot transmit data to the first transmitting device or the second transmitting device.
